(19) United States
(12) Patent Application Publication
(10) Pub. No.: US 2011/0169360 A1
(43) Pub. Date: Jul. 14, 2011

(54) STATOR HOUSING AND BEARING SUPPORT CONNECTION

(76) Inventors: Timothy J. Reinhart, Brownsburg, IN (US); Joel E. Mowatt, Zionsville, IN (US); Randy Lewis Melanson, Pinckney, MI (US); John H. Price, Muncie, IN (US)

(21) Appl. No.: 12/685,919

(22) Filed: Jan. 12, 2010

(51) Int. Cl. H02K 5/16

(52) U.S. Cl. 310/91; 903/915

(57) ABSTRACT

A transmission having an electric motor/generator includes a transmission housing and a bearing support rigidly connected to the transmission housing and substantially enclosed by the transmission housing. A stator housing is substantially enclosed by the transmission housing, and is rigidly joined to the bearing support by a plurality of rivets, such that torque may be transferred between the stator housing and bearing support. The stator housing may be formed from a first material, and the bearing support may be formed from a second material, different from the first material. The stator housing and bearing support meet at an interface region, which may be characterized by an absence of a welded connection between the stator housing and the bearing support. The interface region may be characterized as a slip fit, such that the stator housing and bearing support are matable by hand.

### TECHNICAL FIELD

This disclosure relates to vehicular drivetrains, and more particularly, to transmissions for alternative energy and hybrid vehicles.

### BACKGROUND

Motorized vehicles include a powertrain operable to propel the vehicle and power the onboard vehicle electronics. The powertrain, or drivetrain, generally includes an engine that powers the final drive system through a multi-speed power transmission. Many vehicles are powered by a reciprocating-piston type internal combustion engine (ICE).

Hybrid vehicles utilize multiple, alternative power sources to propel the vehicle, minimizing reliance on the engine for power. A hybrid electric vehicle (HEV), for example, incorporates both electric energy and chemical energy, and converts the same into mechanical power to propel the vehicle and power the vehicle systems. The HEV generally employs one or more electric machines (motor/generator/generators) that operate individually or in concert with the internal combustion engine to propel the vehicle.

The electric machines convert kinetic energy into electric energy which may be stored in an energy storage device. The electric energy from the energy storage device may then be converted back into kinetic energy for propulsion of the vehicle. Electric vehicles also include one or more electric machines and energy storage devices used to propel the vehicle.

### SUMMARY

A transmission having an electric motor/generator is provided. The transmission includes a transmission housing and a bearing support rigidly connected to the transmission housing and substantially enclosed by the transmission housing. A stator housing is substantially enclosed by the transmission housing, and is rigidly joined to the bearing support by a plurality of rivets, such that torque may be transferred between the stator housing and bearing support.

The stator housing may be formed from a first material, and the bearing support may be formed from a second material, different from the first material. The stator housing and bearing support meet at an interface region, which may be characterized by an absence of a welded connection between the stator housing and the bearing support. The interface region may be characterized as a slip fit, such that the stator housing and bearing support are configured to be matable by hand at the interface region.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic representation of a powertrain into which the present invention may be incorporated;

FIG. 2 is a schematic cross-sectional view of a portion of a hybrid transmission, showing the relative locations of the input shaft, motor/generator A, and motor/generator B;

FIG. 3 is a more-detailed, cross-sectional view of a portion of the motor/generator B shown schematically in FIG. 2; and

FIG. 4 is a schematic plan view of a portion of the motor/generator B shown schematically in FIGS. 1, 2 and 3.

### DESCRIPTION OF PREFERRED EMBODIMENTS

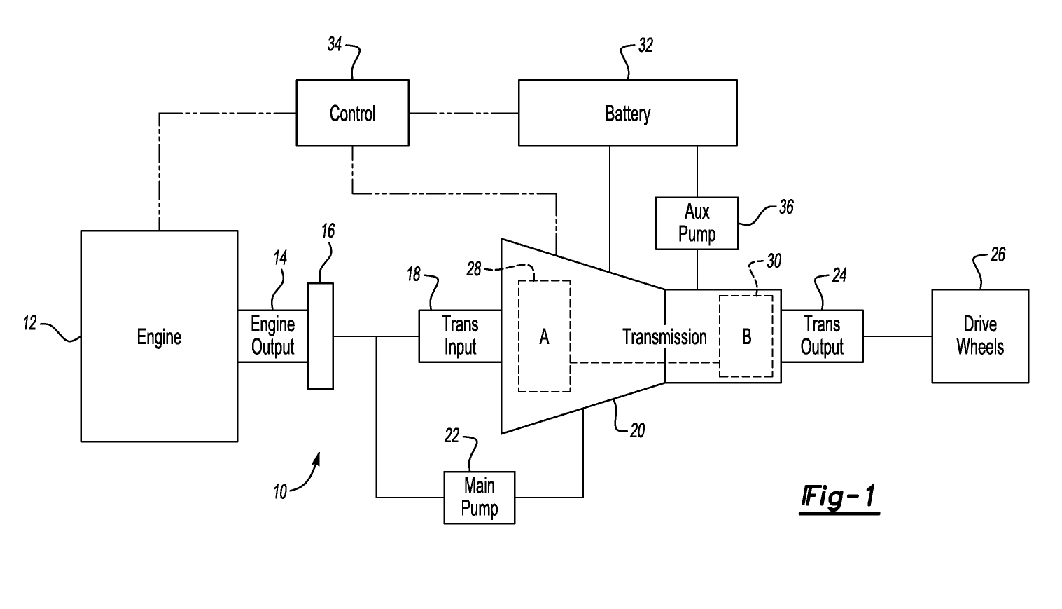

With reference to FIG. 1, there is shown a schematic diagram of a powertrain 10 into which the claimed invention may be incorporated. The powertrain 10 includes an engine 12, which may be any type of internal combustion engine known in the art, turning an engine output 14, which transmits the driving power produced by the engine 12. Driving power is then transferred through a transmission input shaft 18 into a transmission 20. In some embodiments, a damper 16 may be interposed between the engine output 14 and the transmission input shaft 18, or otherwise included in engine output 14.

While the present invention is described in detail with respect to automotive applications, those skilled in the art will recognize the broader applicability of the invention. Additionally, other hybrid configurations may utilize the claimed invention. Those having ordinary skill in the art will further recognize that terms such as “above,” “below,” “upward,” “downward,” et cetera, are used descriptively of the figures, and do not represent limitations on the scope of the invention, as defined by the appended claims.

Input shaft 18 may be operatively connectable to planetary gear members (not shown) or to torque transfer devices (not shown) within transmission 20. The transmission 20 may be a multi-mode, electrically-variable transmission or another hybrid transmission known to those having ordinary skill in the art. For example, and without limitation, the transmission 20 may be utilized in a purely electric vehicle, such that there is no internal combustion engine 12.

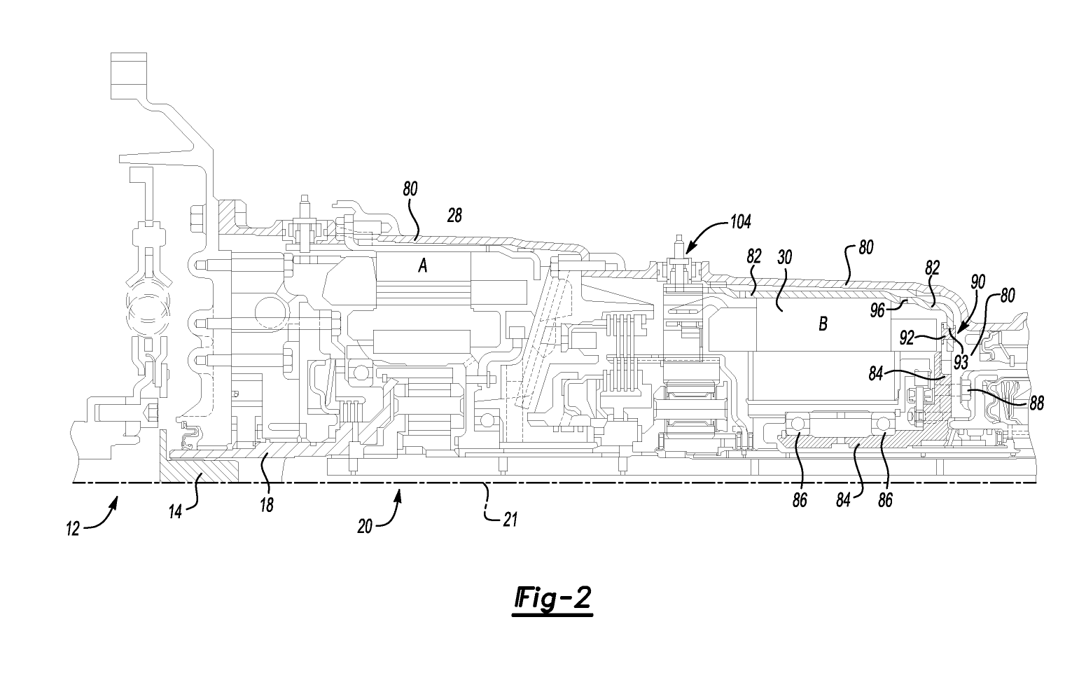

Transmission 20 utilizes input shaft 18 to receive power from the vehicle engine 12 and a transmission output 24 to deliver power to drive the vehicle through one or more drive wheels 26. Transmission 20 shown in FIG. 1 includes a first motor/generator 28 and a second motor/generator 30. Each of the motor/generators 28 and 30 is an electric machine capable of both converting electric power into mechanical power and converting mechanical power into electric power. The first motor/generator 28 may also be referred to as motor/generator A, and second motor/generator 30 may be referred to as motor/generator B. The second motor/generator 30 (motor/generator B) will described in more detail below, with reference to FIGS. 2, 3 and 4.

Alternatively, the transmission 20 may include only one of the first or second motor/generators 28, 30. In other configurations of the powertrain 10 and transmission 20, only the second motor/generator 30 may be located within the transmission 20 and the first motor/generator 28 may be located externally. For example, the first motor/generator 28 may be arranged as a substitute for the internal combustion engine 12, as viewed in the schematic power flow diagram of FIG. 1.

The fluid in transmission 20 is pressurized by a main pump 22. The pressurized fluid may be used for such functions as cooling, lubrication, and, in some cases, operation of the torque transfer devices. Most transmission pumps are directly or indirectly driven by rotation of the engine output member—such as the engine crankshaft, engine driven damper, or torque converter assembly drive hub—to drive the pump rotor.

The transmission 20 may utilize one or more planetary gear sets (not shown in FIG. 1), and may utilize one or more clutches (not shown in FIG. 1) to provide, for example, input split, compound split, and fixed ratio modes of operation. The planetary gear sets may be simple or may be individually compounded.

The motor/generators 28 and 30 are operatively connected to a battery 32, an energy storage device, so that the battery 32 can accept power from, and supply power to, the first and second motor/generator/generators 28 and 30. A control system 34 regulates power flow among the battery 32 and the motor/generators 28 and 30, as well as between the motor/generators 28 and 30.

The control system 34 may further control the engine 12 and operation of the transmission 20 to select the output characteristics transferred to the drive wheels 26. Control system 34 may incorporate multiple control methods and devices. The battery 32 may be a single chemical battery or battery pack, multiple chemical batteries, or other energy storage device suitable for hybrid vehicles. Other electric power sources, such as fuel cells, that have the ability to provide, or store and dispense, electric power may be used in place of battery 32 without altering the concepts of the claimed invention.

In some modes of operation for the powertrain 10, the engine 12 may shut down or turn off completely. This may occur when the control system 34 determines that conditions are suitable for drive wheels 26 to be driven, if at all, solely by alternative power from one or both of motor/generators 28 and 30, or during periods of regenerative braking. While the engine 12 is shut down, the main pump 22 is not being driven, and is therefore not providing pressurized fluid to transmission 20. Powertrain 10 may therefore include an auxiliary pump 36, which may be powered by the battery 32 to provide pressurized fluid to transmission 20 when additional pressure is required.

Referring now to FIG. 2, and with continued reference to FIG. 1, there is shown one possible embodiment of a portion of the powertrain 10 shown schematically in FIG. 1. More specifically, FIG. 2 shows a cross-sectional view of a portion of the upper half of transmission 20, which is an exemplary hybrid transmission into which the features of the claimed invention may be incorporated. In the powertrain 10 shown in FIG. 1, the engine 12 (not shown in FIG. 2) is transferring power through the engine output 14, which may be a crank shaft, a damper hub, or another shaft-type output member capable of transferring power to the transmission 20. Power is transferred to the transmission 20 by the input shaft 18. FIG. 2 shows only the upper half of transmission 20, the lower half being below an axis of rotation 21 or (hereinafter, axis 21). Input shaft 18 is symmetrical about the axis 21, as are many of the other rotating members of transmission 20.

Transmission 20 is substantially enclosed by a main case or transmission housing 80. Inside of transmission 20 are the first motor/generator 28 (motor/generator A, on the left in FIG. 2) and second motor/generator 30 (motor/generator B, on the right in FIG. 2), which may be connected by one or more differential gearing mechanisms and one or more torque transfer devices. The static or stationary portions of the second motor/generator 30 are supported within transmission 20 by a stator housing 82 and a bearing support 84.

The rotating components or portions of the second motor/generator 30 are carried by one or more rotatable bearings 86 attached to the bearing support 84. The bearings 86 allow relative rotation between the static bearing support 84 and the rotating components. Therefore, while stator housing 82 and the bearing support 84 are both grounded to the transmission housing 80, the rotating components of the second motor/generator 30 are still allowed to rotate about the axis 21.

The stator housing 82 to the bearing support 84 are connected by a plurality of rivets 92. Therefore, the stator housing 82 and bearing support 84 are fixed together for common torque transfer. The static portion of the second motor/generator 30 is mated to the transmission 20 by bolting the bearing support 84 to the transmission housing 80 with one or more bolts 88.

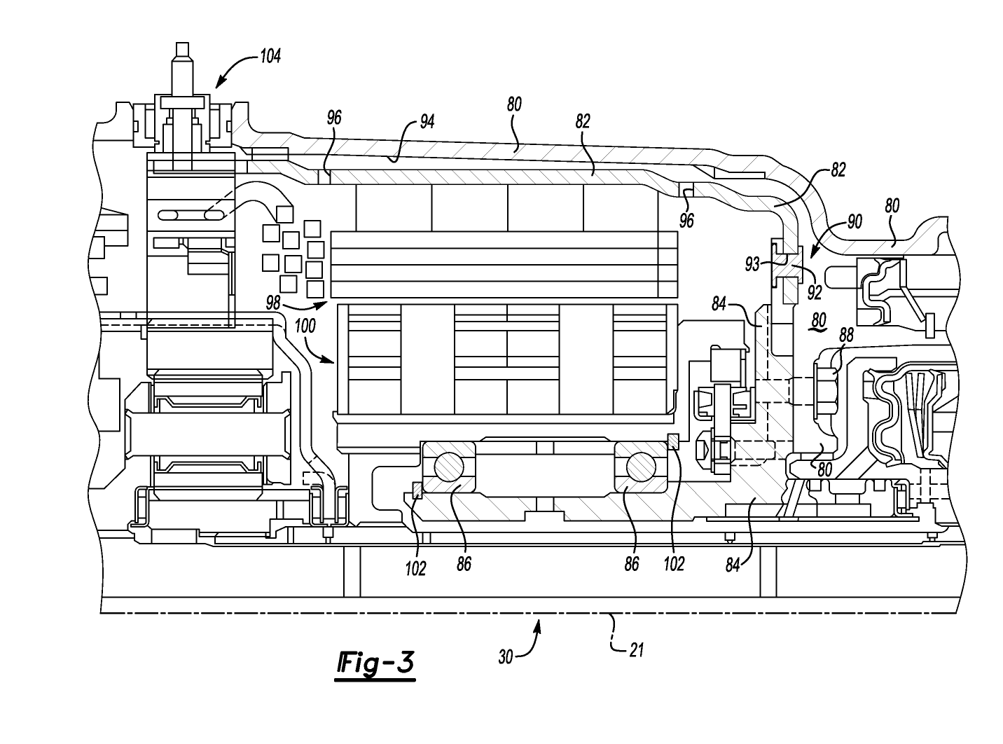

Referring now to FIG. 3, and with continued reference to FIGS. 1 and 2, there is shown a more-detailed cross section of a portion of the second motor/generator 30 shown schematically in FIG. 2, and better shows the interface region 90. Stator housing 82 is rigidly attached to the bearing support 84 by the plurality of rivets 92 at the interface region 90, and bearing support 84 is attached to the transmission housing 80 by bolts 88. Therefore, torque is transferred from the stator housing 82 to the plurality of rivets 92, and then from the plurality of rivets 92 to the bearing support 84, and then from the bearing support 84 to the bolts 88 and transmission housing 80.

In an alternative embodiment of the transmission 20, the interface region may include one or more welds to rigidly attach the stator housing 82 to the bearing support 84. Welded connections may result in heat deformation to one of the welded components. Welding the stator housing 82 to the bearing support 84 would generally require that the bearing support 84 be pressed into the stator housing 82 with a press fit at the interface region 90. For a press fit (also referred to as a force or interference fit), considerable force or pressure is required to assemble the parts, which are then considered more or less permanently assembled, unless subjected to significant torque or force.

However, as shown in FIG. 3, the interface region 90 is characterized by an absence of a welded connection between the stator housing 82 and the bearing support 84. The interface region 90 may further be characterized by an absence of torque transmitting mechanisms other than the plurality of rivets 92. Therefore, the plurality of rivets 92 bear substantially all torque transfer between the stator housing 82 and the bearing support 84.

If the interface region 90 does not include a press-fit connection between the stator housing 82 and bearing support 84, the components may be configured for pilot fit or a slip fit. With a slip fit (also sometimes called a loose, free, or medium fit), the parts are matable by hand, or with a relatively small force, usually only enough force necessary for alignment. The pilot fit will not require the application of large amounts of pressure or force, and is therefore unlikely to cause warping or slight deformation of the assembled parts. Therefore, the stator housing 82 and bearing support 84 may be mated or assembled together by hand at the interface region 90.

Following mating of the stator housing 82 to the bearing support 84, the plurality of rivets 92 are placed into rivet holes 93. Then, one side (either the left or right, as viewed in FIGS. 2 and 3) is deformed or flattened to permanently and rigidly attach the stator housing 82 to the bearing support 84.

The stator housing 82 and bearing support 84 may be formed from different materials. Generally, welded connections are not formed from differing materials. In the embodiment shown, the stator housing 82 may be formed from steel or an alloy thereof. The stator housing 82 may be formed as a single, tubular-stamped housing. The rivet holes 93 may also be stamped holes. Conversely, the bearing support 84 may be cast, as opposed to stamped or otherwise formed, from cast iron. The bearing support 84 may contain internal feed lines or features to transfer fluids. The internal feed features may require internal cores during the casting process. The plurality of rivets 92 may be steel rivets or another rivet formable within the rivet holes 93 to sufficiently join the stator housing 82 to the bearing support 84.

Two or more seals interact with the transmission housing 80 and stator housing 82 to define a pressure cavity 94 into which lubricating and cooling fluid may be pumped. Fluid flows from the pressure cavity 94 through one or more cooling holes 96 into the interior of stator housing 82, where the fluid cools and lubricates the functional elements of the second motor/generator 30; such as a stator and windings 98 and a rotor and rotor hub 100. Therefore, the stator housing 82, bearing support 84, and plurality of rivets 92 are also substantially-enclosed by the transmission housing 80 and subjected to the pressurized (and possibly heated) transmission fluid or oil contained therein.

The rotor and rotor hub 100 are carried against bearing support 84 by the bearings 86, which are held in place by one or more snap rings 102. The bearings 86 allow relative rotation between the bearing support 84 and the rotor and rotor hub 100, allowing the rotor and rotor hub 100 to spin under the influence of magnetic fields between the stator and windings 98 and the rotor and rotor hub 100.

The stator and windings 98 are assembled into the stator housing 82 along a tubular portion thereof, and may be assembled with a press fit. Second motor/generator 30 may be connected to the battery 32 and control system 34 by an interface hub 104 mounted in the transmission housing 80.

From a manufacturing and assembly perspective, this design allows the stator and windings 98 of the second motor/generator 30 to be assembled into the mated stator housing 82 and bearing support 84 first. The rotor and rotor hub 100 and ball bearings 86 may then be installed and held in the second motor/generator 30 with the snap rings 102. The substantially-complete second motor/generator 30 (motor/generator B) assembly may be installed as one substantially-complete module into the transmission housing 80 instead of installing each individual component. This design also allows for the second motor/generator 30 module to be fully tested prior to installation into the transmission housing 80, as bolts 88 allow the whole second motor/generator 30 assembly to simply be bolted to a test fixture (simulating attachment to the transmission housing 80) for pre-installation testing.

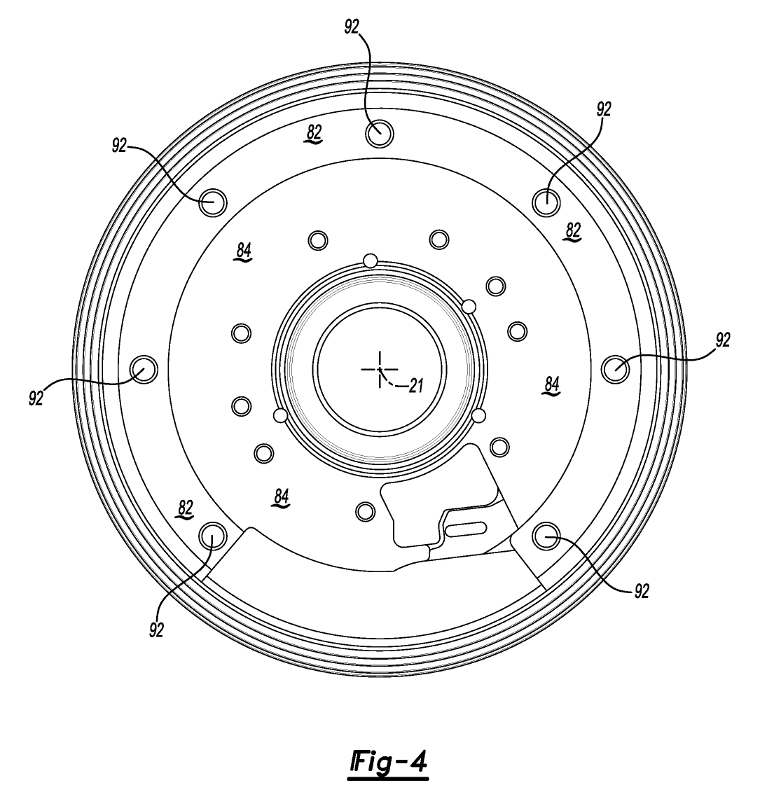

Referring now to FIG. 4, and with continued reference to FIGS. 1-3, there is shown a schematic plan view of a portion of the second motor/generator 30 shown schematically in FIGS. 1, 2 and 3. FIG. 4 shows the stator housing 82, bearing support 84, and plurality of rivets 92 with the transmission housing 80 and remainder of transmission 20 hidden. The viewpoint of FIG. 4 equates to looking at the second motor/generator 30 from the right side of FIGS. 2 and 3.

The axis 21 is at the center of the stator housing 82, and is perpendicular to the viewpoint of FIG. 4. In the second motor/generator 30 shown in FIG. 4, the plurality of rivets 92 are equally-spaced, in the radial direction, away from the axis 21. In order to sufficiently transfer torque between the stator housing 82 and bearing support 84, the second motor/generator 30 may include at least three rivets 92.

In the embodiment shown, the second motor/generator 30 includes seven rivets 92. The seven rivets 92 are disposed in a radial pattern about the axis 21. The radial pattern has equivalent angular spacing between each of the rivets 92, except for two. The radial pattern is an eight-rivet pattern with one rivet missing (what would be the bottom rivet 92, as viewed in FIG. 4).

While the best modes for carrying out the claimed invention have been described in detail, those familiar with the art to which this invention relates will recognize various alternative designs and embodiments for practicing the invention within the scope of the appended claims.

1. A transmission having an electric motor/generator, the transmission comprising:
a transmission housing;
a bearing support rigidly connected to the transmission housing and substantially enclosed by the transmission housing;
a plurality of rivets; and
a stator housing substantially enclosed by the transmission housing, wherein the stator housing is rigidly joined to the bearing support by the plurality of rivets, such that torque may be transferred between the stator housing and bearing support.

2. The transmission of claim 1,
wherein the stator housing is formed from a first material, and
wherein the bearing support is formed from a second material, different from the first material.

3. The transmission of claim 2, wherein the first material is steel and the second material is cast iron.

4. The transmission of claim 3, wherein the stator housing and bearing support meet at an interface region, and wherein the interface region is characterized by an absence of a welded connection between the stator housing and the bearing support.

5. The transmission of claim 4, wherein the interface region is further characterized as a slip fit, such that the stator housing and bearing support are configured to be matable by hand at the interface region.

6. The transmission of claim 5, wherein the interface region is further characterized by an absence of torque transmitting mechanisms other than the plurality of rivets, such that the plurality of rivets bear substantially all torque transfer between the stator housing and the bearing support.

7. The transmission of claim 6, wherein the plurality of rivets includes at least three rivets.

8. The transmission of claim 7,
wherein the bearing support includes an axis of rotation, and
wherein the plurality of rivets includes seven rivets disposed in a radial pattern about the axis of rotation.

9. The transmission of claim 8, further comprising:
a stator rigidly attached to the stator housing;
a rotatable bearing rigidly attached to the bearing support; and
a rotor rigidly attached to the rotatable bearing, such that the rotatable bearing allows relative rotation between the bearing support and the rotor.

10. A transmission having an electric motor/generator, the transmission comprising:
a transmission housing;
a bearing support rigidly connected to the transmission housing and substantially enclosed by the transmission housing;
a plurality of rivets;
a stator housing substantially enclosed by the transmission housing, wherein the stator housing is rigidly joined to the bearing support by the plurality of rivets, such that torque may be transferred between the stator housing and bearing support through the plurality of rivets;
a stator rigidly attached to the stator housing;
a rotatable bearing rigidly attached to the bearing support; and
a rotor rigidly attached to the rotatable bearing, such that the rotatable bearing allows relative rotation between the bearing support and the rotor.

11. The transmission of claim 10, wherein the stator housing and bearing support meet at an interface region, and wherein the interface region is characterized by an absence of a welded connection between the stator housing and the bearing support.

12. The transmission of claim 11, wherein the interface region is further characterized by an absence of torque transmitting mechanisms other than the plurality of rivets, such that the plurality of rivets bear substantially all torque transfer between the stator housing and the bearing support.

13. The transmission of claim 12, wherein the interface region is further characterized as a slip fit, such that the stator housing and bearing support are configured to be matable by hand at the interface region.

14. The transmission of claim 13,
wherein the stator housing is formed from a first material, and
wherein the bearing support is formed from a second material, different from the first material.

15. The transmission of claim 14, wherein the first material is steel and the second material is cast iron.
